(19) United States
(12) Patent Application Publication
(10) Pub. No.: US 2014/0354554 A1
(43) Pub. Date: Dec. 4, 2014

(54) Touch Optimized UI

(71) Applicant: Microsoft Corporation, Redmond, WA (US)

(72) Inventors: Renu Devi, Redmond, WA (US); Kyle Ryan, Sammamish, WA (US)

(73) Assignee: Microsoft Corporation, Redmond, WA (US)

(21) Appl. No.: 13/905,619

(22) Filed: May 30, 2013

(51) Int. Cl. G06F 3/0488; G06F 3/0484; G06F 3/01; G06F 3/0482

(52) U.S. Cl. CPC G06F 3/0488; G06F 3/0482; G06F 3/04842; G06F 3/017
USPC 345/173

(57) ABSTRACT

An improved dynamic user interface is provided. According to a type of input detected, an application UI may be optimized to the type of input. Optimization may include arrangement of functionality controls, as well as interaction models of UI elements to provide a better user experience depending on a type of input mechanism being used. If touch input is used, the functionality controls in a touch-optimized UI may be spaced farther apart, hit target areas may be larger, and behavior of the functionality controls may be optimized for touch input. If a user switches between touch and precision modes (e.g., the user uses a finger tap and a mouse), a precision UI may be presented, where functionality controls may be more compactly arranged and may utilize features specific to a mouse, pen/stylus, or other type of precision input device.

### BACKGROUND

Modern day users use software applications to perform various tasks that may be executed on various types of computing devices (e.g., tablets, smartphones, laptops, etc.). The devices may support more than one mode of input, such as, but not limited to, touch input, mouse input, pen/stylus input, gesture input, etc. To assist users to locate and utilize functionalities of a given application, a user interface (UI) containing a plurality of selectable functionality controls may be provided. An arrangement of the functionality controls may provide for a better user experience depending on a type of input being used. For example, if mouse input is used, where entry may be more precise, a user interface may comprise more options with smaller hit targets. On the contrary, if touch input is used, a user interface allowing for less precise entry, such as a user interface with larger spacing between functionality controls for providing enough space for a user's finger to access options, may be more optimal.

Currently, applications may either provide one kind of user interface (e.g., touch-friendly or UI or a UI designed for more precise input), or may provide an option at the start of the application for allowing a user to choose either one type of user interface or another. If a touch-friendly UI is provided yet a user is using a precise input device, such as a mouse or stylus, the user may become frustrated with a loss of screen estate and a UI that is not optimal for his current choice of input method. The currently selected input method may be different that a default input method for the particular device the user is utilizing. If a user interface designed for more precise input is provided and a user is using touch input, the user may become frustrated due to difficulty in selecting options due to lack of precision from the touch input. If a functionality is provided for allowing a user to select a UI type, the user may be committed to the selected user interface and may be refrained from switching input modes, causing the user to not fully be able to use different input methods when his device may support multi-modal input, and multiple user interface types may be available.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing an improved dynamic user interface. An application UI may be optimized according to a type of input detected. For example, if touch input is used, the UI may be presented in touch-optimized mode, where the UI may be displayed in a manner that is optimized for touch or gesture input. If a user switches between touch and precision modes (e.g., the user uses a finger tap and a mouse), a precision UI may be presented, wherein the precision UI may be optimized for precision input. The UI may respond to a detected input type irrespective of the input type mode currently provided. For example, if a currently provided mode is precision mode and a user uses touch input to select a functionality control, such as a drop down menu, the drop down menu may be displayed such that it may be optimized for touch input.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of one embodiment of a system including an input detection module and a user interface (UI) optimization engine;

FIGS. 2A and 2B are example illustrations of a precision UI and a touch-optimized UI;

FIGS. 3A and 3B are example illustrations of a precision UI and a touch-optimized UI;

FIGS. 4A and 4B are example illustrations of a precision UI and a touch-optimized UI;

FIG. 5 a flow chart of a method for providing an input mode-optimized user interface;

FIGS. 6A and 6B are example illustrations showing a selectable UI mode toggle control displayed on a precision UI and a touch-optimized UI;

FIG. 7 is a block diagram illustrating example physical components of a computing device with which embodiments of the invention may be practiced;

FIGS. 8A and 8B are simplified block diagrams of a mobile computing device with which embodiments of the present invention may be practiced; and

FIG. 9 is a simplified block diagram of a distributed computing system in which embodiments of the present invention may be practiced.

### DETAILED DESCRIPTION

As briefly described above, embodiments of the present invention are directed to providing an improved dynamic user interface.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

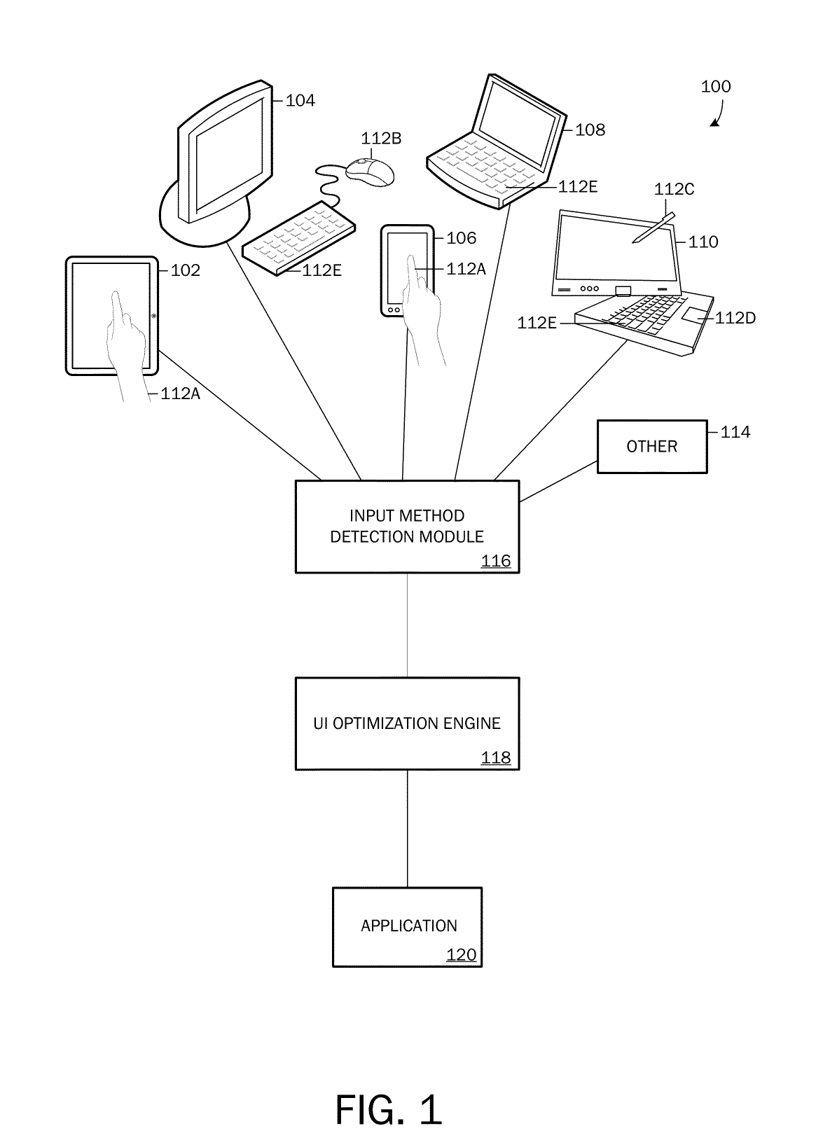

Referring now to the drawings, in which like numerals represent like elements, various embodiments will be described. FIG. 1 illustrates one embodiment of a system 100 incorporating an input detection module 116 and a user interface (UI) optimization engine 118. As was briefly described above, users may use various types of computing devices (e.g., a tablet computing device 102, a desktop computer 104, a mobile communication device 106, a laptop computer 108, a laptop/tablet hybrid computing device 110, or other types of computing devices 114) for executing applications 120 for performing a variety of tasks. Each of the various types of computing devices 102,104,106,108,110,114 may support multi-mode input, that is, each device may be able to receive input via more than one type of input mechanisms 112 (e.g., touch 112A, mouse input 112B, stylus/digital pen input 112C, touchpad 112D, keyboard input 112E, gesture input, etc.).

As can be appreciated, each input method may have its own set of strengths and weaknesses. For example, input via a mouse 112B or pen/stylus 112C may be more precise input methods than input via touch 112A or gesture input (herein collectively referred to as touch input 112A) because of a variety of factors. For example, mouse 112B movements and pen/stylus 112C strokes may provide precise x-y coordinates and may provide a cursor to assist with targeting, whereas a mouse cursor may not be provided to assist with targeting with touch input 112A. Additionally, the contact area of a fingertip may be greater than a single x-y coordinate, and thereby may increase the likelihood of unintended command activations. Because keyboard focus is explicit and keyboard focus may be provided, which may assist with targeting, keyboard input 112E may be considered a more precise input method than touch input 112A. Although mouse 112B, pen/stylus 112C, and keyboard input 112E may be considered to be more precise input methods than touch input 112A, touch input 112A may have other advantages, such as direct manipulation of UI objects through gestures such as tapping, dragging, sliding, pinching, rotating, etc.

A user may utilize an application 120 on a computing device 102,104,106,108,110,114 for a variety of tasks, which may include, for example, to write, calculate, organize, prepare presentations, send and receive electronic mail, make music, and the like. Applications 120 may include thick client applications which may be stored locally on the computing device 102,104,106,108,110,114, or may include thin client applications (i.e., web applications) that may reside on a remote server and accessible over a network, such as the Internet or an intranet. A thin client application may be hosted in a browser-controlled environment or coded in a browser-supported language and reliant on a common web browser to render the application executable on a computing device 102, 104, 106, 108, 110, 114.

To assist users to locate and utilize functionalities of a given application 120, a user interface (UI) containing a plurality of selectable functionality controls may be provided. An arrangement of the functionality controls, as well as interaction models of UI elements, may provide for a better user experience depending on a type of input mechanism 112 being used. As described above, each of a variety of input methods 112 may have its own set of strengths and weaknesses. Accordingly, various UIs may be designed and provided specific to an input type. Embodiments of the present invention provide a precision UI and a touch-optimized UI that may dynamically change between UI types according to a type of input method.

The system 100 may comprise an input method detection module 116 operable to detect an input method 112 (e.g., input via touch 112A, mouse 112B, stylus/digital pen 112C, touchpad 112D, keyboard 112E, gesture, etc.). According to an embodiment, a variety of interpreted computer programming languages (e.g., prototype-based scripting languages such as JavaScript®) and application programming interface (API) data calls may be utilized to detect an input method 112. An input method 112 used to launch an anchor may be determined. For example, an input method 112 may be determined off a click or context menu event.

According to one embodiment, if the application 120 is a web application and a browser is unable to provide such information, an input method 112 may be determined via listening for multiple types of events: a standard on click event and various browser-specific touch events. If a touch start event occurs within a predetermined window of time before a click (e.g., 300 ms), a determination may be made that the input method 112 may be touch 112A. According to another embodiment, when a touch start followed by a touch end is heard without touch moves, a click may be fired, and the click may be tagged as touch. If a pointer event with a touch input type 112 occurs within a predetermined time window before the click, the click may be determined to be touch input 112A. According to another embodiment, determining an input method 112 may comprise listening for a gesture event for tap and determining the input method 112 using information which the browser may provide on input type.

Input method detection may also include user agent string detection. For example, if a browser is being utilized to execute a web application 120, using a user agent string and an API, a determination may be made as to whether the browser may support only mouse input 112B, only touch input 112A, a mixture of mouse and touch input, or other type of input. According to another embodiment, an input mechanism 112 type may be determined via telemetry data. As can be appreciated, input method detection may be performed via various methods.

The system 100 may also comprise a UI optimization engine 118 operable to provide dynamic UI optimization according to a detected or determined input method 112 type. For example, if a user is using touch input 112A, a touch-friendly UI may be displayed. Functionality controls in a touch-friendly UI may be spaced farther apart, hit target areas may be larger, and behavior of the functionality controls may be optimized for touch input 112A. If a user is using a precision input device which enables him to be more precise with hit targeting, for example, if the user is using a mouse 112B, a precision UI may be provided. For example, functionality controls in the precision UI may be more compactly arranged and may utilize features specific to a mouse 112B, such as hovering. Although illustrated in FIG. 1 as separate components, the input detection module 116 and the UI optimization engine 118 may or may not be separate components.

As mentioned above, dynamic UI optimization may be provided. If a first UI that is optimized according to mouse input 112B (or other precision input) is displayed, and if a second UI is launched via touch 112A or gesture input, the second UI may be optimized for touch input 112A. According to one embodiment, the first UI may remain optimized for precision input, while the second UI may be optimized for touch input. According to another embodiment, the first UI and the second UI may be optimized for touch input upon receiving an indication of a launch of the second UI via touch 112A or gesture input. As an example, a user may select a functionality control to bring up a new pane, an editable surface, or a menu (e.g., a flyout menu, a dropdown menu, etc.) via touch 112A or gesture. Accordingly, a second UI (i.e., the new pane, editable surface, or menu) may be displayed, and may comprise touch-friendly features. For example, items in the second UI may be larger in size and may be spaced farther apart.

According to an embodiment, a static UI may be provided. A functionality control for selecting a UI mode (e.g., precision mode or touch-optimized mode) may be provided. If a user manually selects a UI mode, the UI may remain in the selected mode even if the user changes input methods 112.

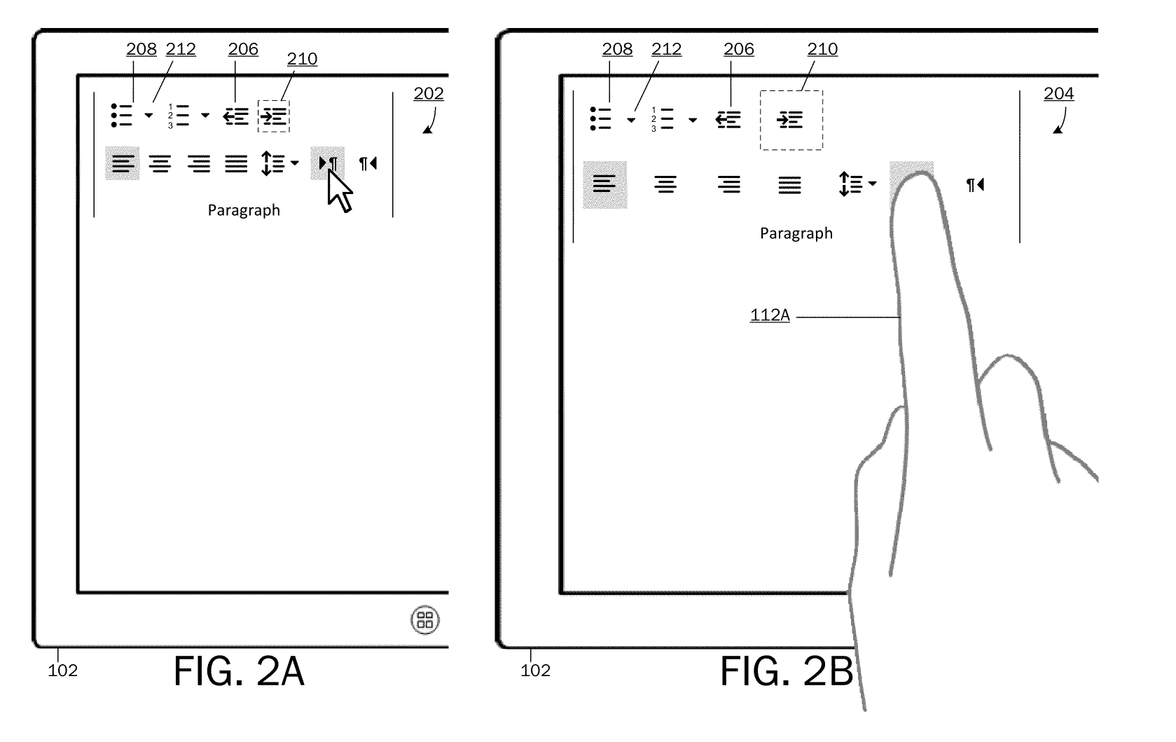

Referring now to FIGS. 2A and 2B, an example of a UI optimized for precision input (herein referred to as precision mode 202) and a UI optimized for touch or gesture input (herein referred to as touch-optimized mode 204) are shown displayed on a tablet computing device 102. Although illustrated on a tablet computing device 102, it is to be understood that the UIs may be displayed on various types of computing devices. As illustrated in both FIGS. 2A and 2B, a plurality of functionality controls 206,208 may be provided in the user interface. According to an embodiment, a UI in touch-optimized mode 204 (FIG. 2B) may include a larger hit target 210 for functionality controls 206,208 than a UI in precision mode 202 (FIG. 2A). To accommodate larger hit targets 210 in touch-optimized mode 204, functionality controls 206,208 may be spaced further apart (vertically and/or horizontally) than functionality controls 206 in precision mode 202 as can be seen by comparing the example UI modes 202, 204 illustrated in FIGS. 2A and 2B.

According to an embodiment, providing a UI in touch-optimized mode 204 may include changing behaviors of functionality controls 206,208. For example, one or more of the functionality controls 206,208 may have more than one option associated with it or may require additional information from a user, for example, a split button control 208. A split button control 208 may include a portion (referred to herein as a dropdown arrow 212), which when selected, may display a secondary UI menu (e.g., dropdown menu, flyout menu, etc.). When a UI is provided in precision mode 202, a secondary UI menu may be launched via a selection of the dropdown arrow 212 of a split button control 208. As can be appreciated, the dropdown portion 212 of a split button control 208 may be narrow and may be difficult to select with a finger when using touch input 112A or gesture input. Accordingly, when a UI is provided in touch-optimized mode 204, a selection of any part of a split button control 208 may cause a dropdown of a secondary UI menu.

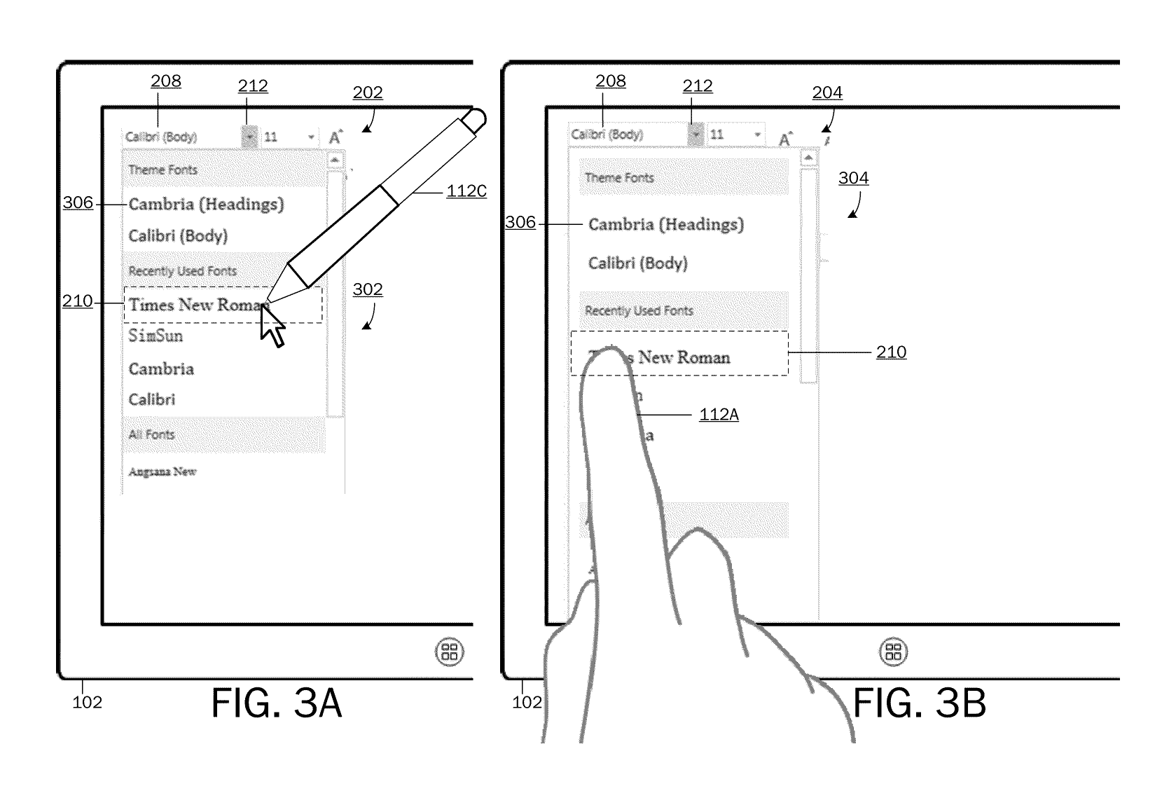

Referring now to FIGS. 3A and 3B, examples of a secondary UI menu 302,304 are shown displayed on a tablet computing device 102. In FIG. 3A, the example secondary UI menu is a dropdown menu in precision mode (herein referred to as a precision secondary UI menu 302). A precision secondary UI menu 302 may be launched via selection by a precision input device, for example, a mouse 112B, a stylus or digital pen 112C, a touchpad 112D, a keyboard 112E, etc.

Providing a dynamic UI comprises presenting a precision secondary UI menu 302 upon receiving input via a precision input device regardless of whether or not the input is received while in precision mode 202 or touch-optimized mode 204. For example, a split button control 208 may be selected by a precision input device in a precision mode 202 UI, or may be selected by a precision input device in a touch-optimized mode 204 UI. Alternatively, embodiments provide for launching a touch-optimized secondary UI menu 304 (illustrated in FIG. 3B) upon receiving input via touch 112A or gesture, regardless of whether or not the input is received while in precision mode 202 or touch-optimized mode 204. For example, a split button control 208 may be selected via touch input 112A in a touch-optimized mode 204 UI, or may be selected by a precision input device in a precision mode 202 UI. That is, when a user switches between touch mode 204 and precision mode 202 (e.g., a user uses touch input 112A and a mouse 112B), an appropriate UI may be presented, wherein the appropriate UI may be optimized for the method of input 112 received.

According to one embodiment, presenting an appropriate UI may include launching a secondary UI menu 302,304 optimized for the method of input 112 received in addition to switching the currently displayed UI, including top level functionality controls 206,208 to a mode optimized for the method of input 112 received. According to another embodiment, presenting an appropriate UI may include launching a secondary UI menu 302,304 optimized for the method of input 112 received, but continuing to display a top level UI in its currently displayed mode. Additionally, if an application interface is minimized or closed and subsequently restored or reopened, the UI may be displayed in a mode (precision 202 or touch-optimized 204) optimized to the input method 112 used to restore or reopen the application interface.

As illustrated, items 306 in a touch-optimized secondary UI menu 304 may be spaced farther apart than items 306 in a precision secondary UI menu 302. The additional spacing may be horizontal and/or vertical spacing. Items 306 in a touch-optimized secondary UI menu 304 may also have an increased hit target area 210 as compared with items 306 in a precision secondary UI menu 302.

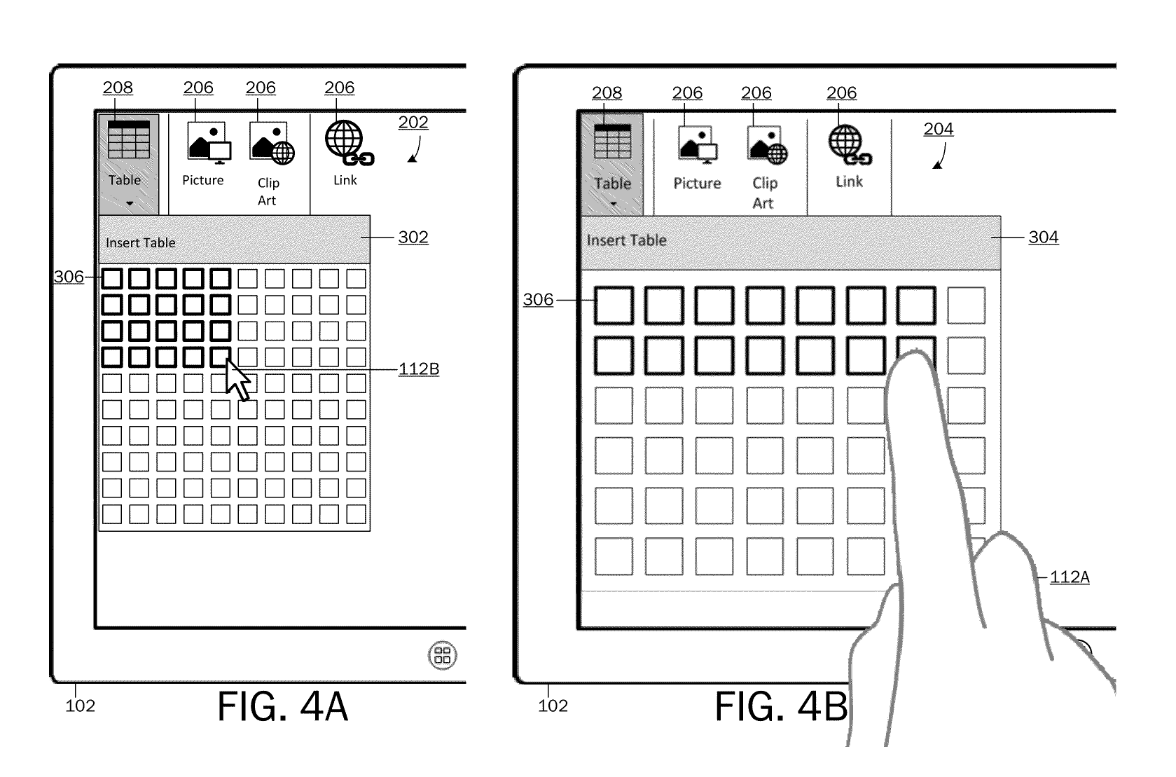

Referring now to FIGS. 4A and 4B, further examples of a precision secondary UI menu 302 (FIG. 4A) and a touch-optimized secondary UI menu 304 (FIG. 4B) are shown. According to an embodiment, and as illustrated in FIG. 4B, providing a UI optimized for touch input 112A may comprise providing a UI with larger selectable functionalities. In the example illustrated in FIG. 4B, the items 306 in the touch-optimized secondary UI menu 304 are larger than the items 306 in the precision secondary UI menu 302 of FIG. 4A. Items 306 in a touch-optimized secondary UI menu 304 may also have increased padding (i.e., larger hit target 210). Accordingly, the items 306 may be easier to touch with confidence by a user.

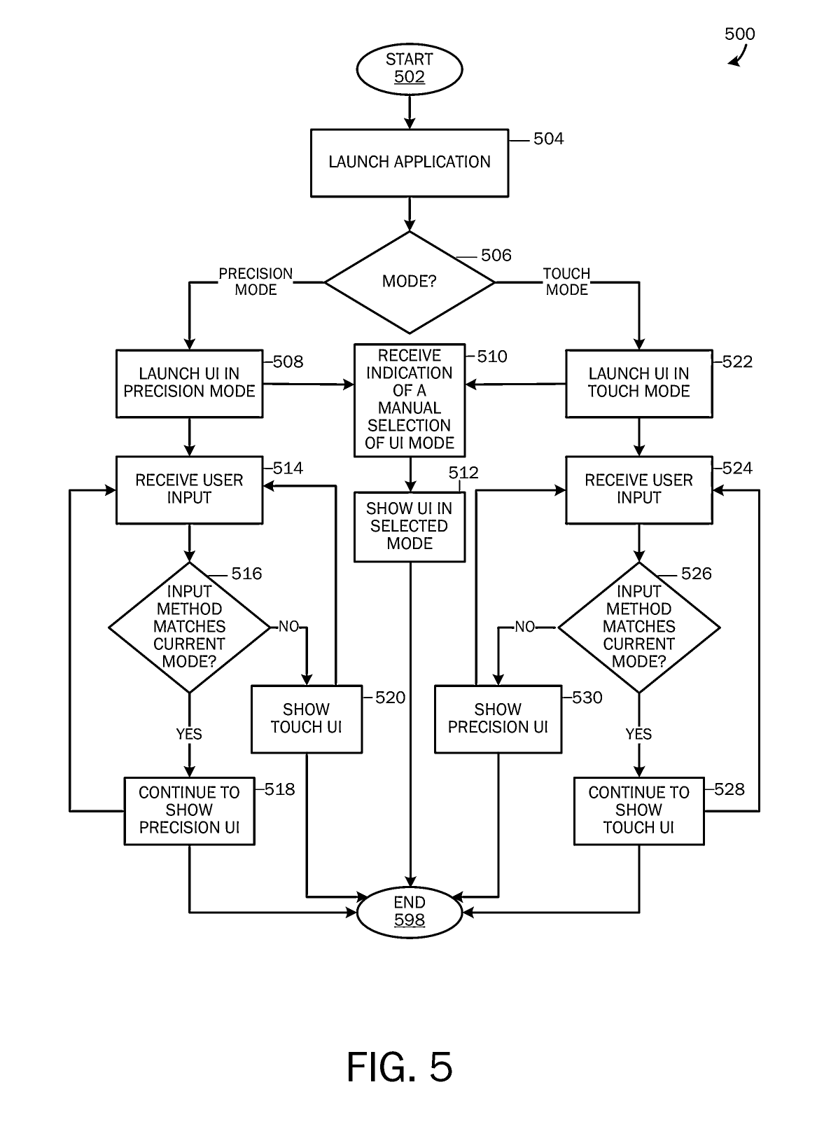

FIG. 5 is a flow chart showing one embodiment of a method 500 for providing a dynamic user interface based on an input method 112. The method 500 starts at OPERATION 502 and proceeds to OPERATION 504 where an application 120 is launched. As described above, an application 120 may be a local application or may be a thin client application (i.e., web application) that may reside on a remote server and accessible over a network. The application 120 may be one of various types of applications, such as, but not limited to, a word processing application, an electronic mail and contacts application, a spreadsheet application, a database application, a slide presentation application, a computer-aided drawing application program, a web browser application, etc.

The method 500 may proceed to DECISION OPERATION 506, where a determination may be made as to what type of UI mode 202,204 to launch in the application 120. Determining which UI mode to launch may be based on a detected input method 112. According to an embodiment, a variety of interpreted computer programming languages (e.g., prototype-based scripting languages such as JavaScript®) and application programming interface (API) data calls may be utilized to detect an input method 112. Input detection may include user agent string detection. For example, if a browser is being utilized to execute a web application 120, using a user agent string and an API, a determination may be made as to whether the browser may support only mouse input 112B, only touch input 112A, a mixture of mouse and touch input, or other input type. According to another embodiment, an input method 112 may be determined via telemetry data. For example, data associated with received clicks (precision input) and touches (touch input) may be tracked and utilized for determining an input type 112. As can be appreciated, there are multiple ways in which an input type 112 may be detected; the above are but a few examples.

If a detected input type 112 is recognized as a precision input method (e.g., mouse 112B, pen/stylus 112C, touchpad 112D, keyboard 112E, etc.) a determination may be made to launch the UI in precision mode 202. Alternatively, if a detected input type 112 is recognized as a non-precision method (e.g., touch 112A, gesture, etc.), a determination may be made to launch the UI in touch-optimized mode 204.

If a determination is made at DECISION OPERATION 506 to launch a UI in precision mode 202, the method 500 may proceed to OPERATION 508, where the UI for the application 120 may be launched in precision mode 202. As described above and with reference to FIGS. 2-4, a UI optimized for precision input methods may comprise characteristics specific to advantages provided by mouse input 112B, stylus/digital pen input 112C, touchpad input 112D, or keyboard input 112E.

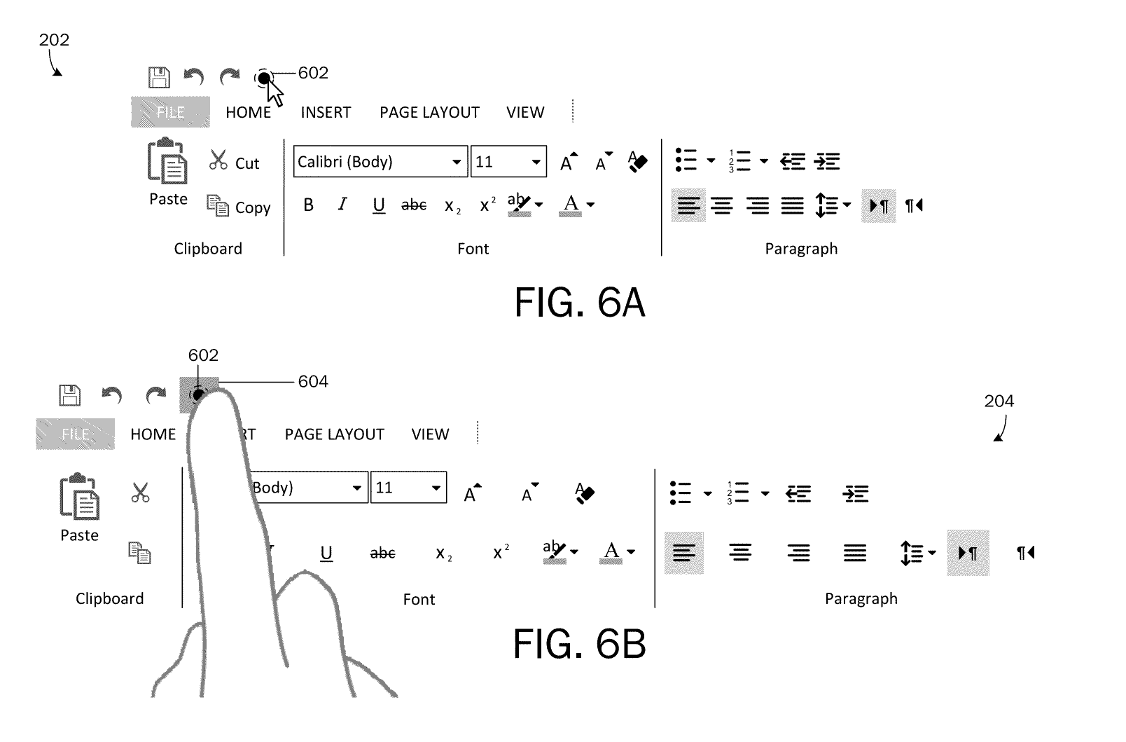

The method 500 may proceed to OPERATION 510 or OPERATION 514. At OPERATION 510, an indication of a manual selection of a UI mode may be received. For example and as illustrated in FIGS. 6A and 6B, a selectable UI mode toggle control 602 may be provided, which when selected, may switch the currently displayed UI mode to an alternate UI mode (e.g., precision mode 202 to touch-optimized mode 204 or touch-optimized mode 204 to precision mode 202). In FIG. 6A, the UI mode toggle control 602 is shown in an example UI in precision mode 202. According to one embodiment, when the UI mode toggle control 602 is unselected, a UI may be displayed in precision mode 202 (FIG. 6A). When the UI mode toggle control 602 is selected (as indicated by highlighting 604 in FIG. 6B), the UI may be displayed in touch-optimized mode 204 (OPERATION 512).

If an indication of a selection of a manual selection of a UI mode toggle control 602 is not received (OPERATION 510,) the method 500 may proceed from OPERATION 508 to OPERATION 514, where a user may interact with the application 120 via one of various input methods 112. For example, user interactions may include, but are not limited to, moving focus, moving, selecting, launching/activating, scrolling, rearranging, dragging, zooming, rotating, inserting, hovering, etc. Upon receiving an indication of user input, a determination may be made at DECISION OPERATION 516 to determine whether the input method 112 associated with the received input matches the currently displayed UI mode (i.e., precision UI 202). For example, a determination may be made as to whether the method via which the received input is made is via a precision input mechanism type (e.g., mouse 112B, pen/stylus 112C, keyboard 112E, touchpad 112D, etc.).

If a determination is made at DECISION OPERATION 516 that the input method 112 matches the currently displayed UI mode (i.e., a precision input device in precision mode 202), the method 500 may proceed to OPERATION 518, where the currently displayed UI mode (i.e., precision mode 202) may continue to be displayed.

Alternatively, if a determination is made at DECISION OPERATION 516 that the input method 112 does not match the currently displayed UI mode (e.g., input via touch 112A in precision mode 202), the method 500 may proceed to OPERATION 520, where the UI may be displayed in touch-optimized mode 204. According to an embodiment and as described above, optimizing a UI for touch input 112A (OPERATION 520) may comprise applying touch-optimized characteristics to all UI elements of the application interface (e.g., top-level functionality controls 206,208 and secondary UI menus 304) or to a portion of the application interface (secondary UI menus 304). As an example and with reference back to FIG. 3B, if a UI is displayed in precision mode 202, and a touch input 112A (e.g., selecting a dropdown arrow 212 of a split functionality control 208) is received, the currently displayed UI may remain displayed in precision mode 202, and items 206 in the dropdown menu (secondary UI menu 304) may be touch-optimized. Referring again to FIG. 5, the method 500 may return to OPERATION 514 where additional user input is received, or may end at OPERATION 598.

If, at DECISION OPERATION 506, a determination is made to launch a UI in touch-optimized mode 204, the method 500 may proceed to OPERATION 522, where the UI for the application 120 may be touch-optimized. As described above and with reference to FIGS. 2-4, a touch-optimized mode 204 UI may comprise characteristics specific to advantages provided by touch input 112A, gesture input, etc.

The method 500 may proceed to OPERATION 510 (described above), or may proceed to OPERATION 524, where user input may be received. A user may interact with the application 120 (e.g., moving focus, moving, selecting, launching/activating, scrolling, rearranging, dragging, zooming, rotating, inserting, hovering, etc.) via one of various input methods.

Upon receiving an indication of user input, a determination may be made at DECISION OPERATION 526 to determine whether the input method 112 associated with the received input matches the currently displayed UI mode (i.e., touch-optimized mode 204). That is, a determination may be made as to whether the method via which the received input is made is via touch 112A or gesture.

If a determination is made at DECISION OPERATION 526 that the input method 112 associated with the user input matches the currently displayed UI mode (i.e., a touch or gesture input in touch-optimized mode 204), the method 500 may proceed to OPERATION 528, where the currently displayed UI mode (i.e., touch-optimized mode 204) may continue to be displayed.

Alternatively, if a determination is made at DECISION OPERATION 526 that the input method 112 does not match the currently displayed UI mode (i.e., a precision input device in touch-optimized mode 204), the method 500 may proceed to OPERATION 530, where the UI may be optimized for precision input (i.e., precision mode 202). As described above, optimizing a UI according to a received input method 112 may comprise optimizing all UI elements of the application interface (e.g., top-level functionality controls 206,208 and secondary UI menus 302) or to a portion of the application interface (secondary UI menus 302). The method 500 may return to OPERATION 524 where additional user input is received, or may end at OPERATION 598.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

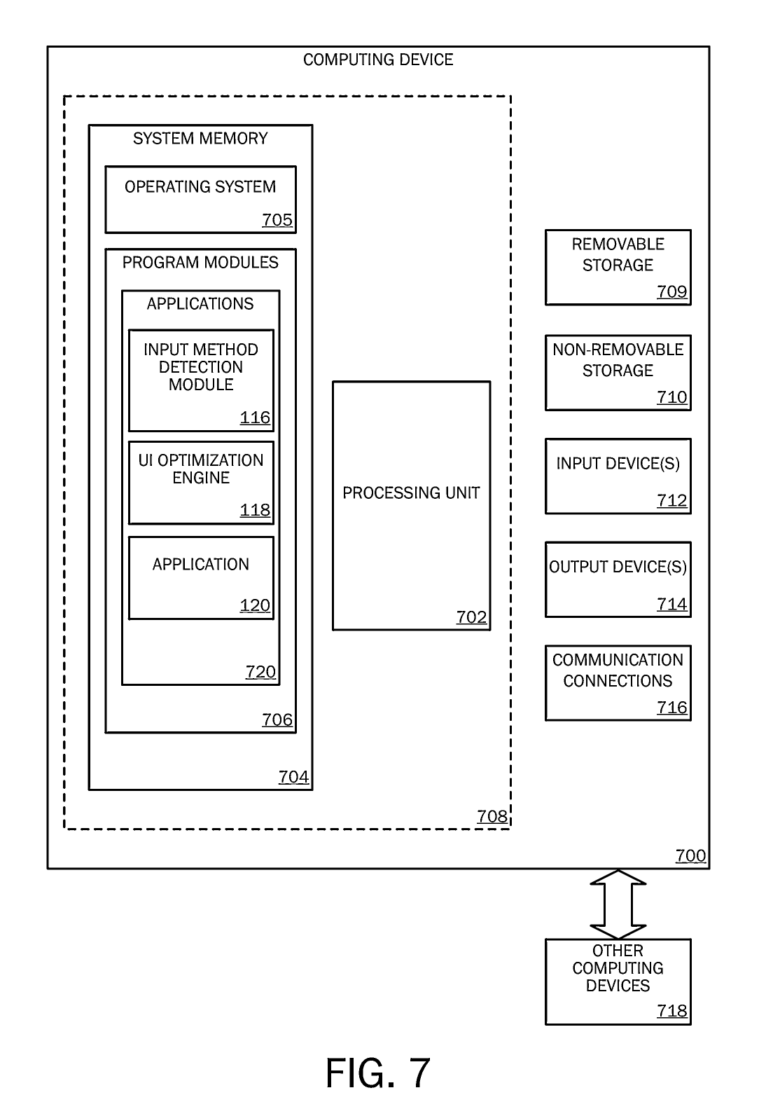

FIGS. 7-9 and the associated descriptions provide a discussion of a variety of operating environments in which embodiments of the invention may be practiced. However, the devices and systems illustrated and discussed with respect to FIGS. 7-9 are for purposes of example and illustration and are not limiting of a vast number of computing device configurations that may be utilized for practicing embodiments of the invention, described herein.

FIG. 7 is a block diagram illustrating physical components (i.e., hardware) of a computing device 700 with which embodiments of the invention may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running software applications 720 such as the input method detection module 116 and the UI optimization engine 118. The operating system 705, for example, may be suitable for controlling the operation of the computing device 700. Furthermore, embodiments of the invention may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., the input method detection module 116 and the UI optimization engine 118) may perform processes including, but not limited to, one or more of the stages of the method 500 illustrated in FIG. 5. Other program modules that may be used in accordance with embodiments of the present invention may include applications 120, such as, electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the input method detection module 116 and the UI optimization engine 118 may be operated via application-specific logic integrated with other components of the computing device 700 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 700 may also have one or more input device(s) 712 such as a keyboard, a mouse, a pen, a sound input device, a touch input device, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

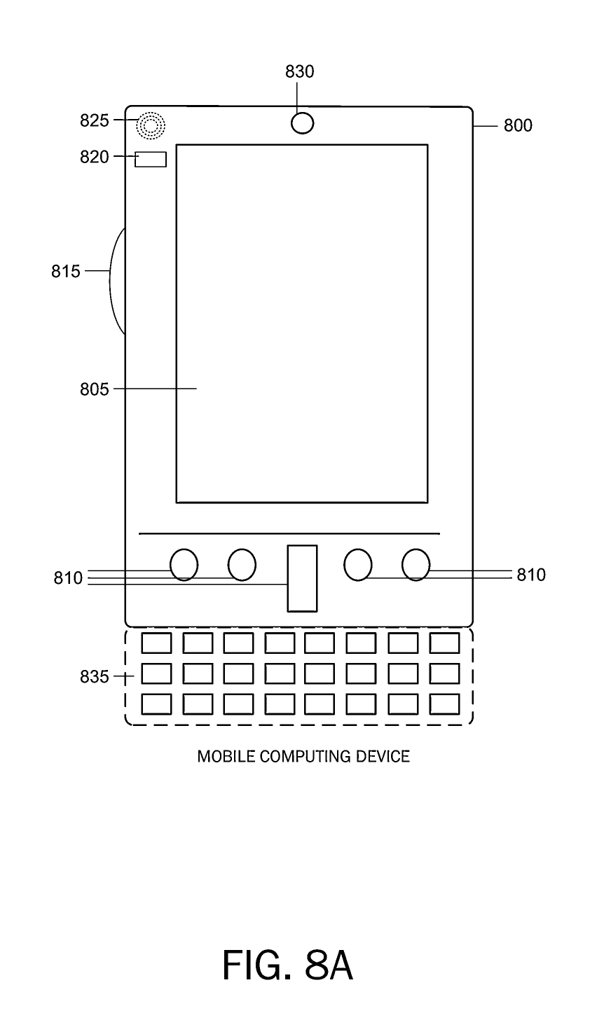

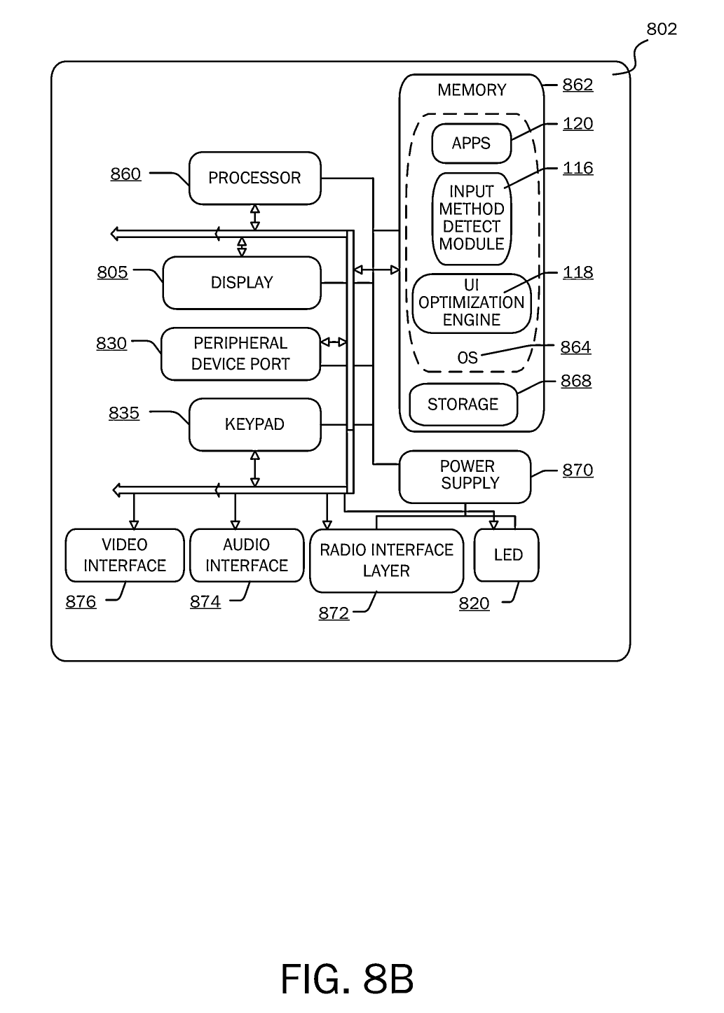

FIGS. 8A and 8B illustrate a mobile computing device 800, for example, a mobile telephone 106, a smart phone, a tablet personal computer 102, a laptop computer 108, and the like, with which embodiments of the invention may be practiced. With reference to FIG. 8A, one embodiment of a mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some embodiments, the mobile computing device 800 incorporates a vibration transducer for providing the user with tactile feedback. In yet another embodiment, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one embodiment of a mobile computing device. That is, the mobile computing device 800 can incorporate a system (i.e., an architecture) 802 to implement some embodiments. In one embodiment, the system 802 is implemented as a “smart phone” capable of running one or more applications (e.g., browser, e-mail, calendaring, contact managers, messaging clients, games, and media clients/players). In some embodiments, the system 802 is integrated as a computing device, such as an integrated personal digital assistant (PDA) and wireless phone.

One or more application programs 120 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 120 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800, including the input detection module 116 and the UI optimization engine 118 described herein.

The system 802 has a power supply 870, which may be implemented as one or more batteries. The power supply 870 might further include an external power source, such as an AC adapter or a powered docking cradle that supplements or recharges the batteries.

The system 802 may also include a radio 872 that performs the function of transmitting and receiving radio frequency communications. The radio 872 facilitates wireless connectivity between the system 802 and the “outside world,” via a communications carrier or service provider. Transmissions to and from the radio 872 are conducted under control of the operating system 864. In other words, communications received by the radio 872 may be disseminated to the application programs 120 via the operating system 864, and vice versa.

The visual indicator 820 may be used to provide visual notifications and/or an audio interface 874 may be used for producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present invention, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio 872 or via a distributed computing network. Similarly, such data/information may be readily transferred between computing devices for storage and use according to well-known data/information transfer and storage means, including electronic mail and collaborative data/information sharing systems.

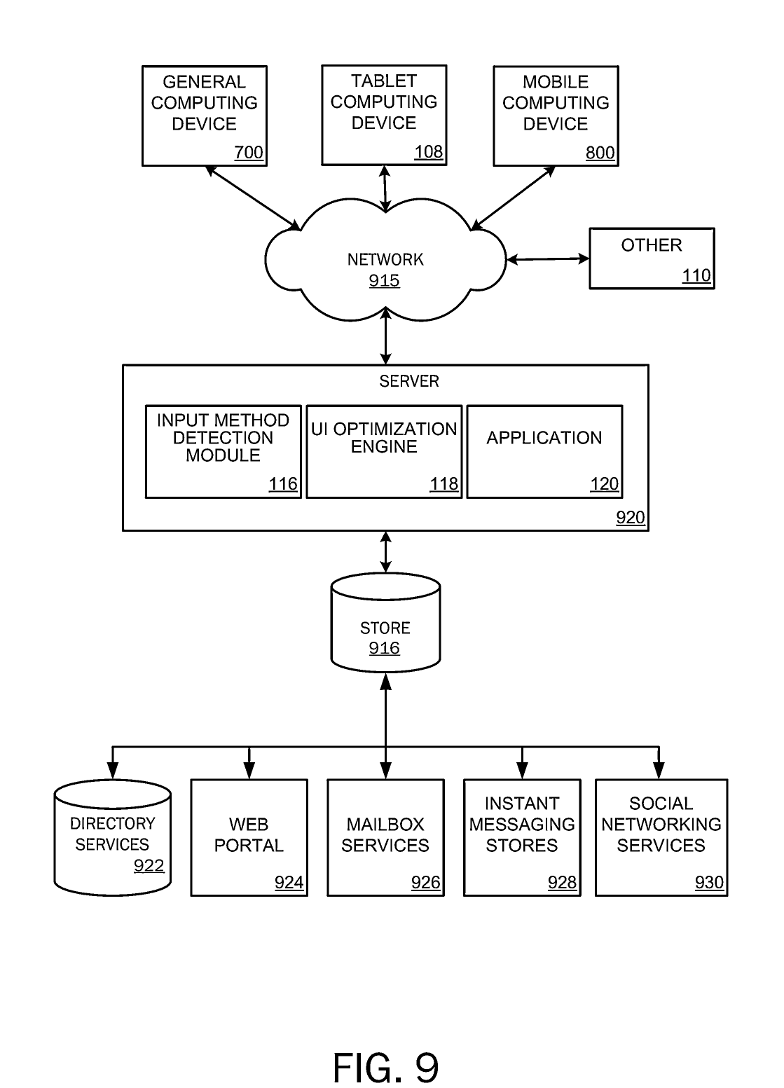

FIG. 9 illustrates one embodiment of the architecture of a system for providing an improved dynamic user interface, as described above. Content developed, interacted with, or edited in association with the input detection module 116 and the UI optimization engine 118 may be stored in different communication channels or other storage types. For example, various documents may be stored using a directory service 922, a web portal 924, a mailbox service 926, an instant messaging store 928, or a social networking site 930. The input detection module 116 and the UI optimization engine 118 may use any of these types of systems or the like for enabling data utilization, as described herein. A server 920 may provide the input detection module 116 and the UI optimization engine 118 to clients. As one example, the server 920 may be a web server providing the input detection module 116 and the UI optimization engine 118 over the web. The server 920 may provide the input detection module 116 and the UI optimization engine 118 over the web to clients through a network 915. By way of example, the client computing device may be implemented and embodied in a personal computer 700, a tablet computing device 108 and/or a mobile computing device 800 (e.g., a smart phone), or other computing device 110. Any of these embodiments of the client computing device 700, 108, 800,110 may obtain content from the store 916.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for providing an optimized dynamic user interface, the method comprising:
receiving an indication to launch an application;
determining whether to display a first user interface in a touch-optimized mode; and
if a determination is made to display the first user interface in a touch-optimized mode, displaying the user interface in a manner that is optimized for touch or gesture input.

2. The method of claim 1, further comprising:
receiving an indication of a selection to display a secondary user interface menu;
detecting an input method associated with the selection to display a secondary user interface menu;
determining whether the detected input method associated with the selection to display a secondary user interface menu is touch or gesture input;
if the detected input method associated with the selection to display a secondary user interface menu is touch or gesture input, displaying the secondary user interface menu in a manner that is optimized for touch or gesture input; and
if the detected input method associated with the selection to display a secondary user interface menu is not touch or gesture input, displaying the secondary user interface menu in a manner that is optimized for precision input.

3. The method of claim 2, wherein receiving an indication of a selection to display a secondary user interface menu comprises receiving an indication of a selection to display one or more of:
a dropdown menu;
a flyout menu; or
a contextual menu.

4. The method of claim 2, wherein displaying the secondary user interface menu in a manner that is optimized for touch or gesture input comprises one or more of:
enlarging items in the secondary user interface;
providing extra spacing between items in the secondary user interface;
expanding a hit target area for items in the secondary user interface; or
changing behavior of secondary user interface items in a manner that is optimized for touch or gesture input.

5. The method of claim 2, wherein displaying the secondary user interface menu in a manner that is optimized for precision input further comprises displaying the first user interface in a manner that is optimized for precision input.

6. The method of claim 1, wherein determining whether to display the first user interface in a touch-optimized mode comprises determining whether a computing device on which the application is being executed supports multi-modal input.

7. The method of claim 6, wherein determining whether a computing device on which the application is being executed supports multi-modal input comprises determining if the computing device supports touch or gesture input and precision input.

8. The method of claim 1, further comprising:
receiving an indication of user interaction with the application;
detecting an input method associated with the user interaction;
determining whether the detected input method associated with the user action is touch or gesture input;
if the detected input method associated with the user action is touch or gesture input, displaying the first user interface in a manner that is optimized for touch or gesture input; and
if the detected input method associated with the user action is not touch or gesture input, displaying the first user interface in a manner that is optimized for precision input.

9. The method of claim 8, wherein displaying the first user interface in a manner that is optimized for touch or gesture input comprises one or more of:
enlarging functionality controls in the first user interface;
providing extra spacing between functionality controls;
expanding a hit target area for functionality controls; or
changing behavior of functionality controls in a manner that is optimized for touch or gesture input.

10. The method of claim 1, wherein if a determination is made to not display the first user interface in a touch-optimized mode, displaying the first user interface in a manner that is optimized for precision input.

11. The method of claim 1, further comprising providing a functionality control for allowing a user to manually select a touch-optimized user interface or a precision user interface.

12. A system for providing an optimized dynamic user interface, the system comprising:
one or more processors; and
a memory coupled to the one or more processors, the one or more processors operable to:
receive an indication to launch an application;
determine whether to display a first user interface in a touch-optimized mode; and
if a determination is made to display the first user interface in a touch-optimized mode, display the user interface in a manner that is optimized for touch or gesture input.

13. The system of claim 12, wherein the processor is operable to determine whether to display a first user interface in a touch-optimized mode via using a user agent string to determine possible methods of input.

14. The system of claim 12, wherein the processor is further operable to:
receive an indication of user interaction with the application;
detect an input method associated with the user interaction;
determine whether the detected input method associated with the user action is touch or gesture input;
if the detected input method associated with the user action is touch or gesture input, display the first user interface in a manner that is optimized for touch or gesture input; and
if the detected input method associated with the user action is not touch or gesture input, display the first user interface in a manner that is optimized for precision input.

15. The system of claim 14, wherein a first user interface that is displayed in a manner that is optimized for touch or gesture input comprises one or more of:
enlarged functionality controls;
extra spacing between functionality controls;
expanded hit target areas for functionality controls; or
changed behavior of functionality controls in a manner that is optimized for touch or gesture input.

16. The system of claim 14, wherein the processor is operable to determine whether the detected input method associated with the user action is touch or gesture input via determining if a touch event is received within a predetermined time interval before receiving a click event.

17. The system of claim 12, wherein the processor is further operable to:
receive an indication of a selection to display a secondary user interface menu;
detect an input method associated with the selection to display a secondary user interface menu;
determine whether the detected input method associated with the selection to display a secondary user interface menu is touch or gesture input;
if the detected input method associated with the selection to display a secondary user interface menu is touch or gesture input, display the secondary user interface menu in a manner that is optimized for touch or gesture input; and
if the detected input method associated with the selection to display a secondary user interface menu is not touch or gesture input, display the secondary user interface menu in a manner that is optimized for precision input.

18. The system of claim 17, wherein a secondary user interface menu that is displayed in a manner that is optimized for touch or gesture input comprises one or more of:
enlarged items in the secondary user interface;
extra spacing between items in the secondary user interface;
expanded hit target area for items in the secondary user interface; or
changed behavior for items such that selection of the items are optimized for touch or gesture input.

19. A computer readable medium containing computer executable instructions which, when executed by a computer, perform a method for providing an optimized dynamic user interface, the method comprising:
receiving an indication to launch an application;
determining whether to display a first user interface in a touch-optimized mode;
if a determination is made to display the first user interface in a touch-optimized mode, displaying the first user interface in a manner that is optimized for touch or gesture input, wherein displaying the first user interface in a manner that is optimized for touch or gesture input comprises one or more of:
enlarging functionality controls in the first user interface;
providing extra spacing between functionality controls;
expanding a hit target area for functionality controls; or
changing behavior of functionality controls in a manner that is optimized for touch or gesture input;
receiving an indication of user interaction with the application;
detecting an input method associated with the user interaction;
determining whether the detected input method associated with the user action is touch or gesture input;
if the detected input method associated with the user action is touch or gesture input, displaying the first user interface in a manner that is optimized for touch or gesture input; and
if the detected input method associated with the user action is not touch or gesture input, displaying the first user interface in a manner that is optimized for precision input.

20. The computer readable medium of claim 19, further comprising:
receiving an indication of a selection to display a secondary user interface menu;
detecting an input method associated with the selection to display a secondary user interface menu;
determining whether the detected input method associated with the selection to display a secondary user interface menu is touch or gesture input;
if the detected input method associated with the selection to display a secondary user interface menu is touch or gesture input, displaying the secondary user interface menu in a manner that is optimized for touch or gesture input, wherein displaying the secondary user interface menu in a manner that is optimized for touch or gesture input comprises one or more of:
enlarging items in the secondary user interface;
providing extra spacing between items in the secondary user interface;
expanding a hit target area for items in the secondary user interface; or
changing behavior of secondary user interface items in a manner that is optimized for touch or gesture input; and
if the detected input method associated with the selection to display a secondary user interface menu is not touch or gesture input, displaying the secondary user interface menu in a manner that is optimized for precision input.
